(19) United States
(12) Patent Application Publication
(10) Pub. No.: US 2014/0015932 A1
(43) Pub. Date: Jan. 16, 2014

(54) 3DIMENSION IMAGE SENSOR AND SYSTEM INCLUDING THE SAME

(71) Applicant: Samsung Electronics Co., Ltd., Suwon-Si (KR)

(72) Inventors: Won Joo KIM, Hwaseong-si (KR); Doo Cheol PARK, Hwaseong-si (KR); Yoon Dong PARK, Osan-si (KR); Jung Bin YUN, Hwaseong-si (KR); Kwang Min LEE, Seoul (KR)

(21) Appl. No.: 13/940,419

(22) Filed: Jul. 12, 2013

(30) Foreign Application Priority Data
Jul. 13, 2012 (KR) 10-2012-0076476

(51) Int. Cl. H04N 13/02

(52) U.S. Cl. CPC H04N 13/0257
USPC 348/46

(57) ABSTRACT

A 3D image sensor includes a first color filter configured to pass wavelengths of a first region of visible light and wavelengths of infrared light; a second color filter configured to pass wavelengths of a second region of visible light and the wavelengths of infrared light; and an infrared sensor configured to detect the wavelengths of infrared light passed through the first color filter.

### CROSS-REFERENCE TO RELATED APPLICATIONS

This application claims priority under 35 U.S.C. §119 to Korean Patent Application No. 10-2012-0076476, filed on Jul. 13, 2012, in the Korean Intellectual Property Office, the entire contents of which are incorporated herein by reference.

### BACKGROUND

1. Field

Example embodiments of inventive concepts relate to an image sensor, and more particularly, to a 3-dimension image sensor capable of generating color information and depth information simultaneously and a system including the same.

2. Related Art

It is necessary to generate color information and depth information to provide 3D images to a user. A number of image sensors may be used to generate the color information and the depth information. However, as compact products have been requested, a technology generating the color information and the depth information in one chip is requested.

Even though there are many methods for embodying the depth information and the color information into one chip, they are actually difficult to be embodied. For example, when one 3D image sensor is used for generating the depth information and the color information by using the methods, inter-pixel interference may prevent the 3D image sensor from generating the depth information and the color information effectively.

### SUMMARY

At least one example embodiment of the inventive concepts provides a 3D image sensor including a first color filter configured to pass wavelengths of a first region of visible light and wavelengths of infrared light; a second color filter configured to pass wavelengths of a second region of visible light and the wavelengths of infrared light; and an infrared sensor configured to detect the wavelengths of infrared light passed through the first color filter.

According to at least one example embodiment of the inventive concepts, the 3D image sensor may further include a near-infrared pass filter located between the first color filter and the infrared sensor. The 3D image sensor may further include an infrared filter located between the first color filter and the second color filter and configured to pass the wavelengths of infrared light.

The size of the first color filter and the size of the infrared filter may be the same.

The 3D image sensor includes an optical sensor configured to generate photoelectrons in response to the wavelengths of infrared light passed through the infrared filter. The 3D image sensor may be configured to compensate color information generated by the first color filter using the photoelectrons generated in response to the wavelengths of light passed through the infrared filter.

The size of the infrared sensor may be larger than the size of the first color filter.

At least one example embodiment of the inventive concepts provides a 3D image sensing system including a dual band pass filter configured to pass wavelengths of visible light; and a pixel array including a color pixel region configured to generate color information by transmitting the wavelengths of visible light.

The pixel array may include a near-infrared filter configured to pass the wavelengths of infrared light such that the wavelengths of infrared light passed by the near-infrared filter are incident on the infrared sensor.

The pixel array may include a color filter configured to pass the wavelengths of infrared light and the wavelengths of visible light.

The size of the infrared sensor may be larger than the size of the color filter.

The pixel array may include an infrared filter configured to pass the wavelengths of infrared light.

The size of the color filter and the size of the infrared filter may be the same.

The pixel array may include an optical detector configured to generate photoelectrons in response to the wavelengths of infrared light passed through the infrared filter.

The 3D image sensing system may be a portable electronic device.

According to at least one example embodiment, a 3D image sensor may include a first color filter configured to pass wavelengths of light within a first wavelength range of visible light and configured to pass wavelengths of infrared light; a first color sensor configured to generate photoelectrons in response to the wavelengths of light of the first wavelength range of visible light; and an infrared sensor located below the first color sensor and configured to generate photoelectrons in response to the wavelengths of infrared light.

The 3D image sensor may further include a first infrared filter located in between the first color sensor and the infrared sensor, the first infrared filter being configured to filter out wavelengths of visible light and pass wavelengths of infrared light.

The 3D image sensor may further include a second infrared filter configured to filter out wavelengths of visible light and pass wavelengths of infrared light, wherein the second infrared filter is located adjacent to the first color filter and above the first infrared filter.

The 3D image sensor may further include an optical detector configured to generate photoelectrons in response to the wavelengths of infrared light passed through the second infrared filter, wherein the 3D image sensor is configured to compensate color information generated by the first color sensor based on the photoelectrons generated by the optical detector.

The 3D image sensor may further include a second color filter configured to pass wavelengths of light within a second wavelength range of visible light and configured to pass wavelengths of infrared light, the first wavelength range being different from the second wavelength range; and a second color sensor configured to generate photoelectrons in response to the wavelengths of light of the first wavelength range of visible light.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a side view of a camera module according to at least one example embodiment of the inventive concepts;

FIG. 2 is a block diagram of the camera module shown in FIG. 1;

FIG. 3 is a cross-sectional view of a pixel array shown in FIG. 2 according to at least one example embodiment of the inventive concepts;

FIG. 4 is a cross-sectional view of a pixel array shown in FIG. 2 according to another exemplary embodiment of the inventive concepts;

FIG. 5 is a cross-sectional view of a pixel array shown in FIG. 2 according to yet another exemplary embodiment of the inventive concepts;

FIG. 6 is a cross-sectional view of a pixel array shown in FIG. 2 according to still yet another exemplary embodiment of the inventive concepts;

FIG. 7 is a top view of the pixel array shown in FIG. 2 according to at least one example embodiment of the inventive concepts;

FIG. 8 is a top view of the pixel array shown in FIG. 2 according to another exemplary embodiment of the inventive concepts;

FIG. 9 is a block diagram of a 3D image sensing system including the camera module shown in FIG. 1; and

FIG. 10 is a block diagram of another 3D image sensing system including the camera module of FIG. 1.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

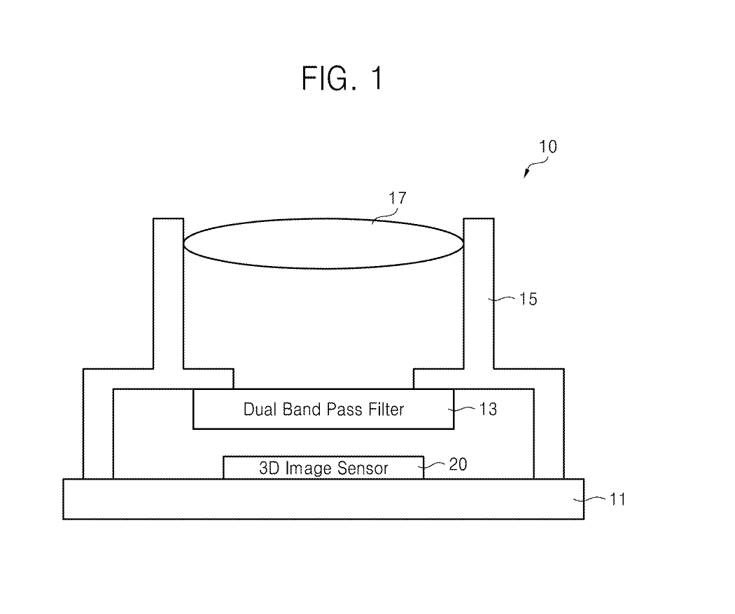

FIG. 1 is a side view of a camera module according to at least one example embodiment of the inventive concepts. Referring to FIG. 1, the camera module 10 includes a board 11, a dual band pass filter 13, a lens holder 15, a lens 17, and a 3D image sensor 20.

The dual band pass filter 13 passes wavelengths of visible region and wavelengths of infrared region. The 3D image sensor 20 generates color information and depth information by using the wavelengths of visible region and the wavelengths of infrared region. The 3D image sensor 20 is mounted on the board 11.

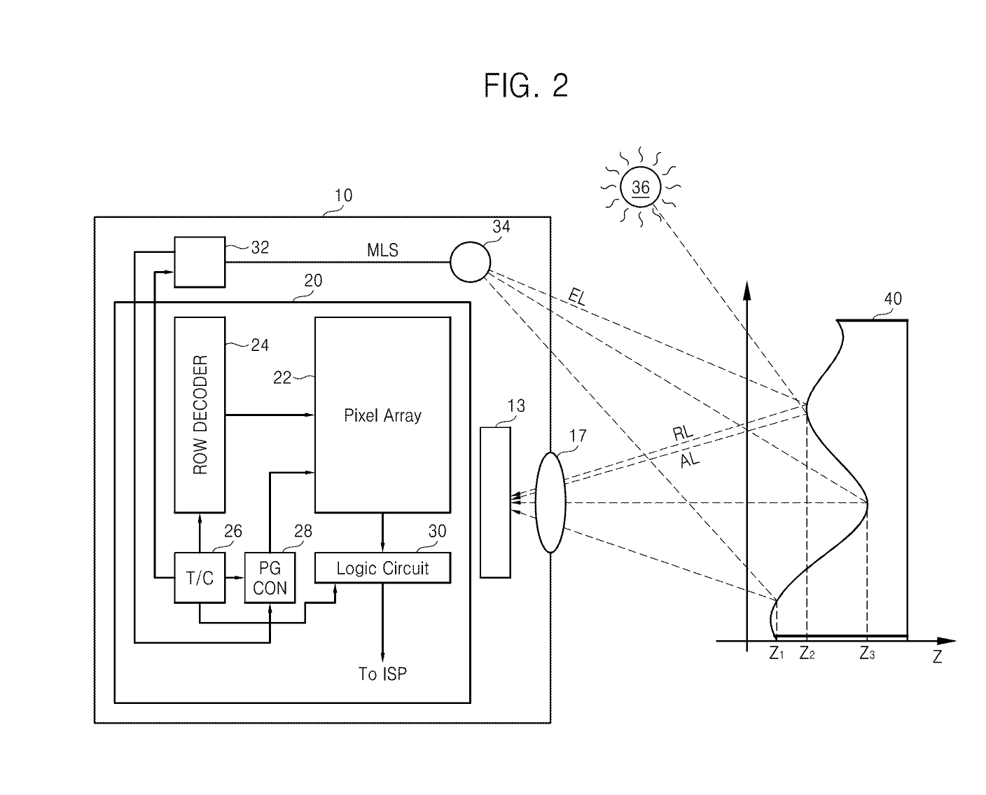

FIG. 2 is a block diagram of the camera module shown in FIG. 1. Referring to FIGS. 1 and 2, the 3D image sensor 20 capable of generating color information and depth information by using a time of flight (TOF) principle includes a pixel array 22, a row decoder 24, a timing controller 26, a photogate controller 28, and a logic circuit 30.

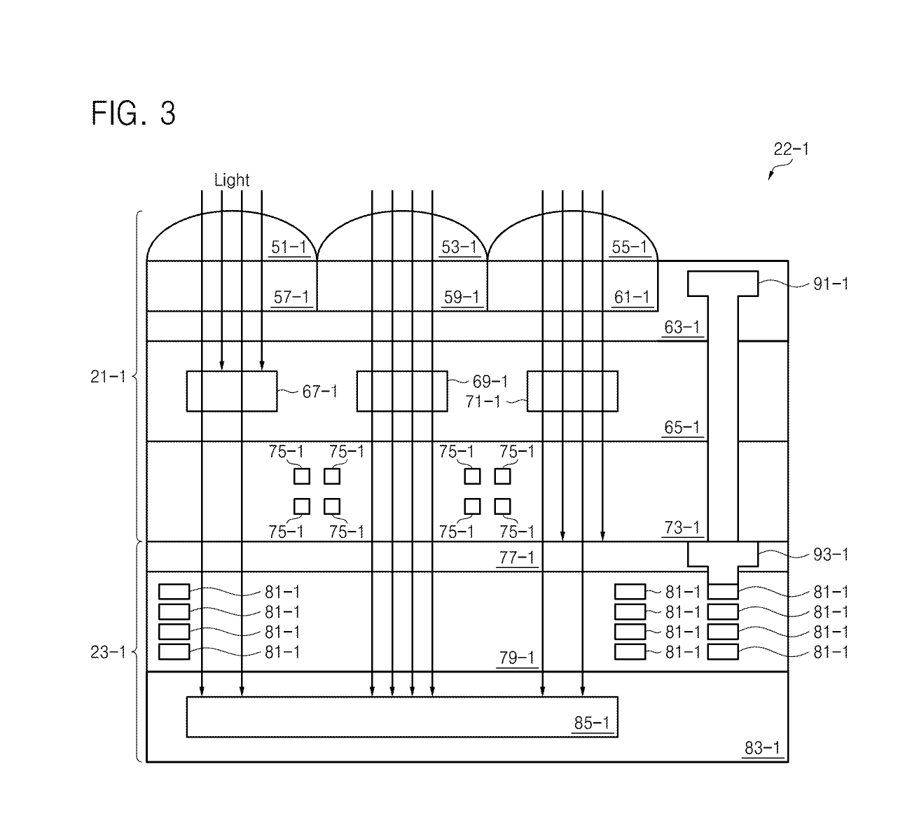

The pixel array 22 will be described in FIGS. 3 through 8 in detail.

The row decoder 24 selects any one of rows in response to a row address output from the timing controller 26. Here, the row denotes assembly of pixels arranged in the X-direction in the pixel array 22. The photogate controller 28 generates photogate control signals and provides the photogate control signals to the pixel array 22 under the control of the timing controller 26.

The logic circuit 30 processes signals detected by the pixels embodied in the pixel array 22 to generate color information and depth information under the control of the timing controller 26 and outputs the processed signals into an image signal processor (ISP). The logic circuit 30 is embodied into two divisions, a circuit for processing detected signals for generating color information and a circuit for processing detected signals for generating depth information.

The image signal processor may calculate color information and depth information based on the processed signals. The 3D image sensor 20 and the image signal processor may be embodied into one chip or separated chips.

According to an exemplary embodiment, the logic circuit 30 may include an analog-digital conversion block (not shown) capable of converting detection signals output from the pixel array 22 into digital signals. According to another exemplary embodiment, the logic circuit 30 may include a correlated double sampling (CDS) block (not shown) for performing CDS with respect to the detection signals output from the pixel array 22 and an analog-digital conversion block (not shown) for converting the signals output from the CDS block into digital signals. Also, the logic circuit 30 may further include a column decoder (not shown) for outputting output signals of the analog-digital conversion block into the image signal processor under the control of the timing controller 26.

A light source driver 32 may generate a clock signal (MLS) capable of driving a light source 34 under the control of the timing controller 26. The light source 34 radiates a modulated optical signal EL into an object 40. Examples of the light source 34 include, for example, one or more of a Light Emitting Diode (LED), Organic Light-Emitting Diode (OLED), infrared diode, and a laser diode. The modulated optical signal EL may be a sinusoidal wave or a square wave. The light source 34 is used for generating depth information. The light source 34 may be embodied as one or more light sources.

The light source driver 32 provides a clock signal MLS or information about the clock signal MLS to a photogate controller 28.

Optical signal RL may be, for example, light reflected from the modulated optical signal EL. When the modulated signal EL output from the light source 34 is reflected from the object 40, and the object 40 has different distances Z1, Z2, and Z3, a distance Z may be calculated as followings. For example, when the modulated optical signal EL is cos ωt, and the optical signal RL incident to an infrared sensor (not shown) or an optical signal RL detected by the infrared sensor is cos (ωt+φ), a phase shift φ by TOF is as followings;

φ=2*ω*Z/C=2*(2πf)*Z/C,

wherein C is the speed of light. Accordingly, the distance Z from the light source 34 or the pixel array 22 to the object 40 may be obtained by followings;

Z=φ*C/(2*ω)=φ*C/(2*(2πf))

The light source driver 32 and the light source 34 may be embodied into one chip along with the image sensor 20.

The reflected light signal RL is input to the pixel array 22 through the lens 17. The light AL is light reflected by the surrounding light 36 and is also input to the pixel array 22 through the lens 17. The reflected light AL is used for generating color information. The light signal RL incident to the pixel array 22 through the lens may be detected by the infrared sensor.

FIG. 3 is a cross-sectional view of the pixel array shown in FIG. 2 according to at least one example embodiment of the inventive concepts. Referring to FIGS. 1 and 3, the pixel array 22-1 may be divided into a color pixel region 21-1 and a depth pixel region 23-1.

The color pixel region 21-1 includes micro lenses 51-1, 53-1, and 55-1, color filters 57-1 and 61-1, an anti-reflective layer 63-1, a first epitaxial layer 65-1, a first inter-metal dielectric layer 73-1, and a first pad 91-1.

Each of the micro lenses 51-1, 53-1, and 55-1 concentrates light incident from the outside. The color pixel region 21-1 may be embodied without the micro lenses 51-1, 53-1, and 55-1 in some embodiments. The light incident from the outside includes the light AL reflected by the surrounding light 36 and the light signal RL reflected by the light source 34. The light signal RL is used for generating depth information. The light incident from the outside includes wavelengths of visible region and wavelengths of infrared region passed through the dual band pass filter 13.

Each of the color filters 57-1 and 61-1 transmits wavelengths of the visible region and wavelengths of the infrared region. For example, each of the color filters 57-1 and 61-1 may be include at least one of a blue filter and a red filter. The blue filter passes wavelengths of blue region within the visible region and wavelengths of infrared region. The red filter passes wavelengths of red region within visible region and wavelengths of infrared region. The wavelengths become longer from a blue region toward a red region of visible region. For example, when the color filters 57-1 and 61-1 are a blue filter and a red filter, respectively, almost all of the wavelengths passed through the blue filter may be transmitted to an optical detector 67-1, and the wavelengths passed through the red filter may be transmitted further than the wavelengths passed through the blue filter.

According to at least one example embodiment of the example embodiments, the color filter 57-1 or 61-1 may be a cyan filter, magenta filter, or yellow filter. The cyan filter transmits wavelengths of 450˜550 nm range within the visible region and wavelengths of infrared region. The magenta filter transmits wavelengths of 400˜480 nm range within the visible region and wavelengths of infrared region. The yellow filter transmits wavelengths of 500˜600 nm range within the visible region and wavelengths of infrared region.

The color pixel region 21-1 includes an infrared filter 59-1. The wavelengths of infrared region are longer than the wavelengths of visible region. Thus, when the infrared filter 59-1 is used, the wavelengths of the infrared region are transmitted to the infrared sensor 85-1. A color filter (for example, a green filter) may be used instead of the infrared filter. The green filter transmits wavelengths of green region in within the visible region and wavelengths of infrared region.

The anti-reflective layer 63-1 is used for reducing reflection. The anti-reflective layer 63-1 increases contrast of image. The first epitaxial layer 65-1 includes optical detectors 67-1, 69-1, and 71-1.

Each of the optical detectors 67-1, 69-1, and 71-1 generates a photoelectron in response to the light input from the outside. That is, each of the optical detectors 67-1, 69-1, and 71-1 generates photoelectrons in response to the light including wavelengths of visible region and wavelengths of infrared region. The optical detectors 67-1 and 71-1 are used for generating color information. The light passed through the infrared filter 59-1 is converted into photoelectrons by the optical detector 69-1. The converted photoelectrons may be used for compensating the color information.

Each of the optical detectors 67-1, 69-1 and 71-1 is formed on the first epitaxial layer 65-1. Each of the optical detectors 67-1, 69-1 and 71-1 is a photosensitive element and may be embodied as, for example, one or more of a photodiode, phototransistor, photogate, or pinned photodiode (PPD).

The inter-metal dielectric layer 73-1 may be formed in an oxide layer or a composite layer of oxide layer and nitride layer. The oxide layer may be, for example, a silicon oxide layer. The inter-metal dielectric layer 73-1 may include metals 75-1. An electric wiring required for the sensing operation of the color pixel region 21-1 may be formed by metals 75-1. The metals 75-1 may include, for example, one or more of copper, titanium, and titanium nitride.

The color pixel region 21-1 may be embodied in the form of a back side illuminated (BSI) structure. The depth pixel region 23-1 includes a second inter-metal dielectric layer 79-1, a second epitaxial layer (83-1), and a second pad 93-1. The depth pixel 23-1 may further include a near-infrared pass filter 77-1. The near-infrared pass filter 77-1 may be required to prevent long wavelengths (for example, wavelengths of red region) of visible region from being transmitted to the infrared sensor 85-1. According to at least one example embodiment of the inventive concepts, the wavelengths of light passed by the near-infrared pass filter 77-1 may include wavelengths smaller than those passed by the infrared filter 59-1. For example, the near-infrared pass filter 77-1 may pass wavelengths of light above 820 mm while the infrared filter 59-1 may pass wavelengths of light above 850 mm.

The second inter-metal dielectric layer 79-1 may be formed in an oxide layer or a composite layer of oxide layer and nitride layer. The oxide layer may be, for example, a silicon oxide layer. The second inter-metal dielectric layer 79-1 may include metals 81-1. An electric wiring required for the sensing operation of the color pixel region 23-1 may be formed by metal 81-1.

The infrared sensor 85-1 is formed on the second epitaxial layer 83-1. The infrared sensor 85-1 detects wavelengths of infrared region. That is, the infrared sensor 85-1 generates photoelectrons in response to the light including wavelengths of infrared region. The light is incident by the light source 34. The infrared sensor 85-1 is used for generating depth information. The infrared sensor 85-1 may be embodied by using a photo gate (not shown).

According to at least one example embodiment of the inventive concepts, the size of the infrared sensor 85-1 may be larger than the size of the color filter 57-1 or 61-1. The depth pixel region 23-1 may be embodied in the form of a front side illuminated (FSI) structure. According to at least one example embodiment of the inventive concepts, bonding may be required once to manufacture the pixel array 22-1. The first pad 91-1 is located on the second pad 93-1. That is, according to at least one example embodiment of the inventive concepts, the color pixel region 21-1 is stacked on the depth pixel region 23-1.

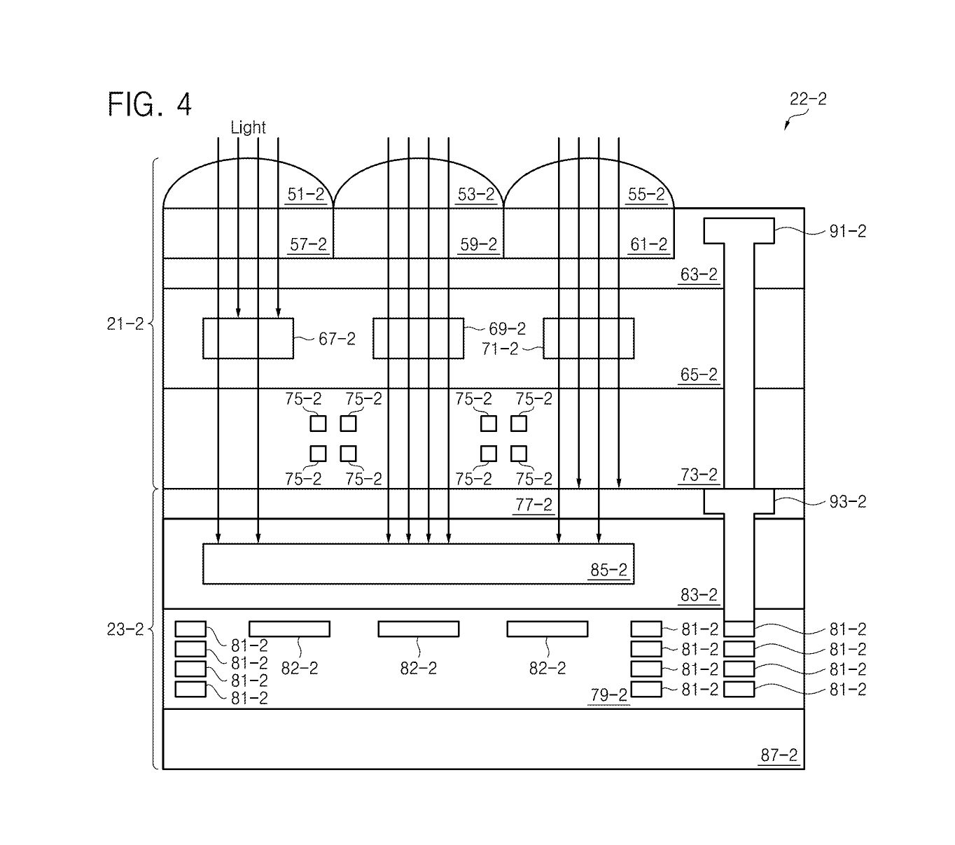

FIG. 4 is a cross-sectional view of the pixel array shown in FIG. 2 according to another exemplary embodiment. Referring to FIGS. 2 and 4, the pixel array 22-2 may be divided into a color pixel region 21-2 and a depth pixel region 23-2.

The color pixel region 21-2 includes micro lenses 51-2, 53-2, and 55-2, color filters 57-2, 61-2, an infrared filter 59-2, an anti-reflective layer 63-2, a first epitaxial layer 65-2, a first inter-metal dielectric layer 73-2, and a first pad 91-1. According to at least one example embodiment of the inventive concepts, the color pixel region 21-2 may have the same structure and function as the color pixel region 21-1 of FIG. 3. Accordingly, detailed descriptions of components 51-2, 53-2, 55-2, 57-2, 59-2, 61-2, 63-2, 65-2, 73-2, and 91-2 of FIG. 4 are omitted.

The depth pixel region 23-2 includes a second epitaxial layer 83-2, a second inter-metal dielectric layer 79-2, a carrier substrate 87-2, and a second pad 93-2. An infrared filter 85-2 is formed on the second epitaxial layer 83-2. According to at least one example embodiment of the inventive concepts, the infrared sensor 85-2 may have the same structure and function as the infrared sensor 85-1 of FIG. 3. Accordingly, detailed descriptions of the infrared sensor 85-2 are omitted.

The second inter-metal dielectric layer 79-2 may be formed in an oxide layer or a composite layer of oxide layer and nitride layer. The oxide layer may be, for example a silicon oxide layer. The second inter-metal dielectric layer 79-2 may include metals 81-2, 82-2. Electric wiring used for the sensing operation of the depth pixel region 23-2 may be formed by metals 81-2. Further, the metals 82-2 may be used to reflect the light incident through the infrared sensor 85-1 back to the infrared sensor 85-1.

The carrier substrate 87-2 may be a silicon substrate. The depth pixel region 23-2 may further include a near-infrared pass filter 77-2. The near-infrared pass filter 77-2 passes wavelengths of near-infrared pass filter region to transmit wavelengths of infrared region to the infrared sensor 85-2. The depth pixel region 23-2 may be embodied in the form. of a back side illuminated (BSI) structure. According to at least one example embodiment of the inventive concepts, bonding may be required twice to manufacture the pixel array 22-2. The first pad 91-2 is located on the second pad 93-2.

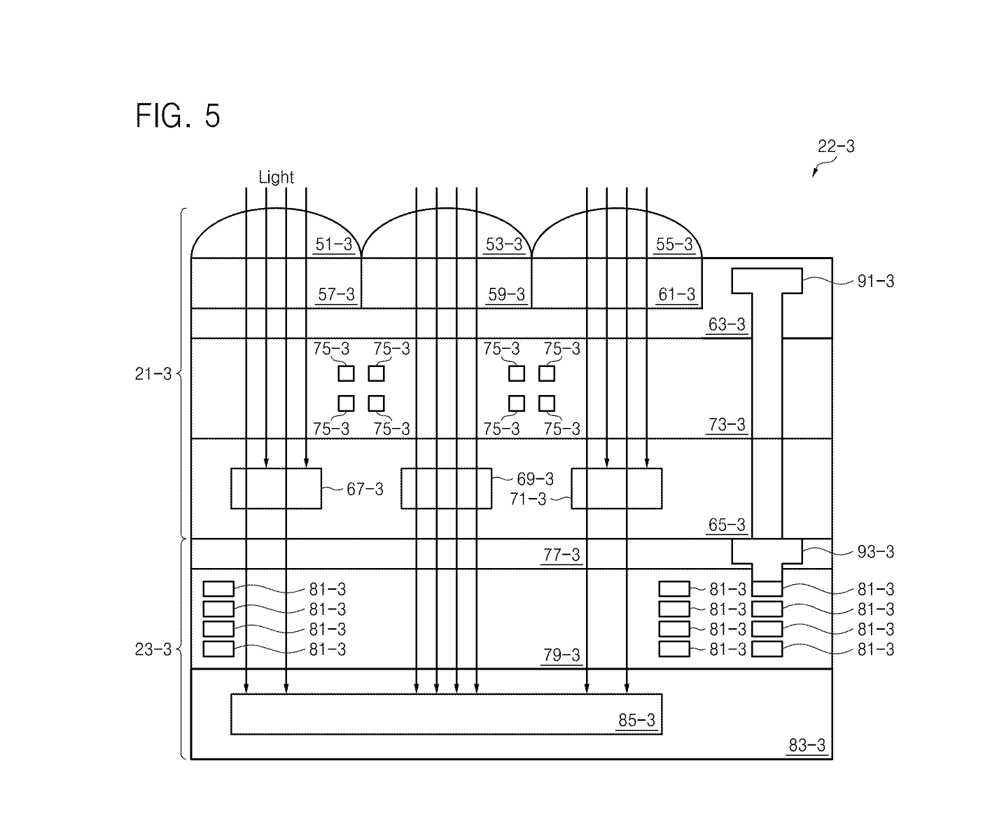

FIG. 5 is a cross-sectional view of the pixel array shown in FIG. 2 according to yet another exemplary embodiment of the inventive concepts. Referring to FIGS. 2 and 5, the pixel array 22-3 may be divided into a color pixel region 21-3 and a depth pixel region 23-3.

The color pixel region 21-3 includes micro lenses 51-3, 53-3, and 55-3, color filters 57-3, 61-3, an anti-reflective layer 63-3, a first epitaxial layer 65-3, a first inter-metal dielectric layer 73-3, and a first pad 93-3.

According to at least one example embodiment of the inventive concepts, the micro lenses 51-3, 53-3, and 55-3, color filters 57-3, 61-3, the anti-reflective layer 63-3, and the infrared filter 59-3 may have the same structure and functions as the micro lenses 51-1, 53-1, and 55-1, color filters 57-1, 61-1, the anti-reflective layer 63-1, and the infrared filter 59-1 of FIG. 3. Accordingly, detailed descriptions of the above-referenced components of pixel region 21-3 are omitted.

The first epitaxial layer 65-3 includes optical detectors 67-3, 69-3, and 71-3. The first inter-metal dielectric layer 73-3 includes metals 75-3. According to at least one example embodiment of the inventive concepts, the optical detectors 67-3, 69-3, 71-3 and the metals 75-3 may have the same structure and functions as the optical detectors 67-1, 69-1, 71-1 and the metal 75-1 of FIG. 3. Accordingly, detailed descriptions of the above-referenced components of pixel region 21-3 are omitted.

The color pixel region 21-3 may be embodied in the form of a front side illuminated (FSI) structure. According to at least one example embodiment of the inventive concepts, the depth pixel region 23-3 may be the same as the depth pixel region 23-1 of FIG. 3, Accordingly, detailed descriptions of the pixel region 23-3 are omitted. The first pad 91-3 is located on a second pad 93-3.

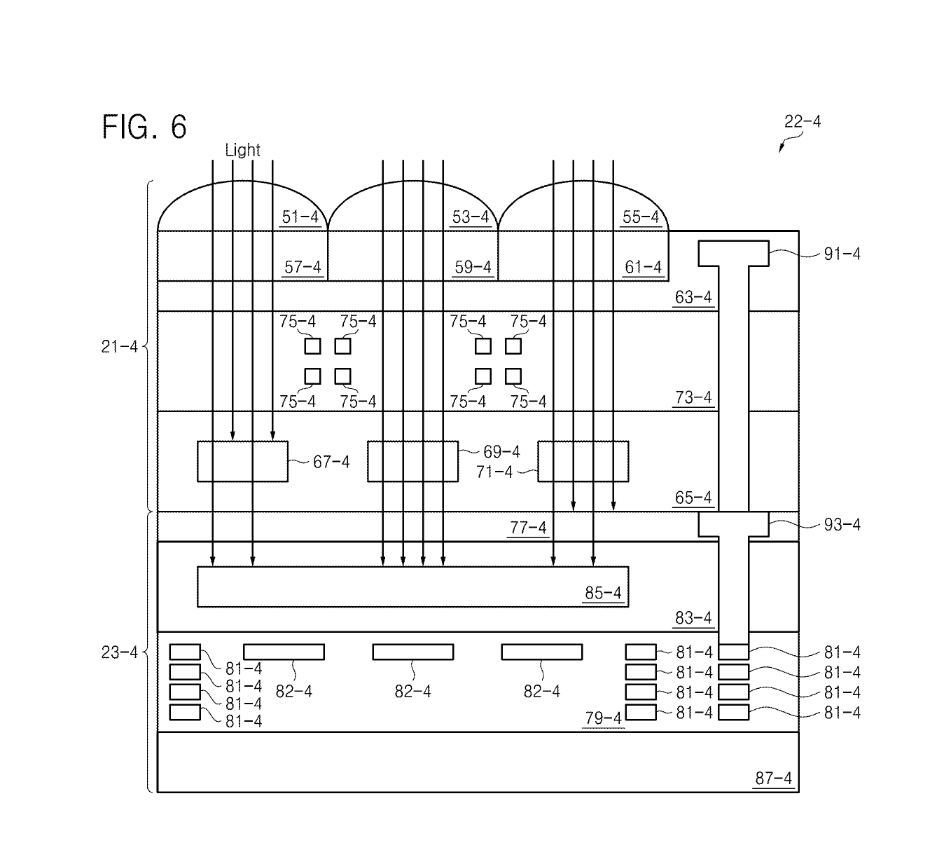

FIG. 6 is a cross-sectional view of the pixel array shown in FIG. 2 according to still yet another exemplary embodiment of the inventive concepts. Referring to FIGS. 2 and 6, the pixel array 22-4 may be divided into a color pixel region 21-4 and a depth pixel region 23-4. According to at least one example embodiment of the inventive concepts, the color pixel region 21-4 may be the same as the color pixel region 21-3 of FIG. 5. Accordingly, detailed descriptions of the above-referenced components of pixel region 21-4 are omitted. Also, the depth pixel region 23-4 is identical to the depth pixel region 23-2, thereby omitting detailed descriptions thereof.

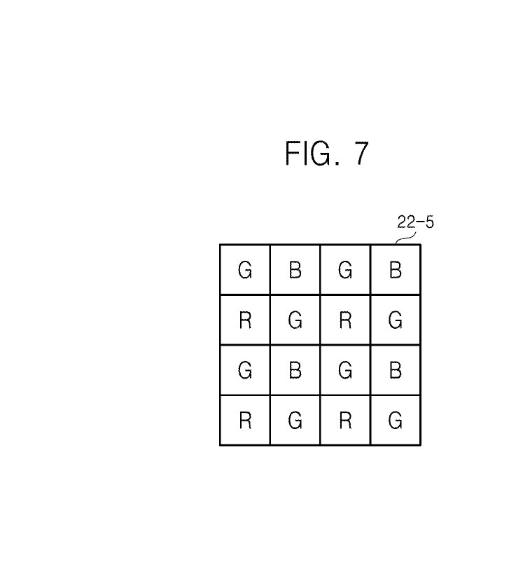

FIG. 7 is a top view of the pixel array 22 shown in FIG. 2. Referring to FIGS. 2 and 7, the pixel array 22 may be embodied as an M×N matrix (where M and N are natural numbers). However, for convenience of explanation, FIG. 7 will be explained with reference to an example where matrix 22-5 is a 4×4 matrix.

The 4×4 matrix 22-5 includes red filters R, green filters G, and blue filters B. According to at least one example embodiment of the inventive concepts, each filter R, G, and B may have the same size. Further, according to at least one example embodiment of the inventive concepts, the 4×4 matrix may include cyan filters, magenta filters, or yellow filters instead of one or all of the red filters R, green filters G, and blue filters B.

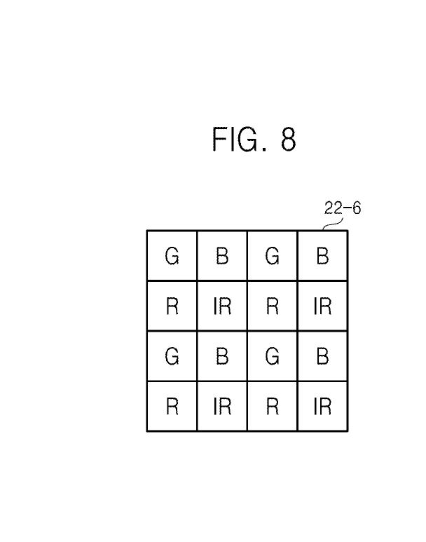

FIG. 8 is a top view of the pixel array 22 shown in FIG. 2 according to another exemplary embodiment. Referring to FIGS. 2 and 8, as is discussed above, the pixel array 22 may be embodied as an M×N matrix. However, 4×4 matrix 22-6 is shown as an example for convenience of explanation. The 4×4 matrix 22-6 includes red filters R, green filters G, blue filters B, and infrared filters IR. According to at least one example embodiment of the inventive concepts, each filter R, G, B, and IR may have the same size. Further, according to at least one example embodiment of the inventive concepts, the 4×4 matrix may include cyan filters, magenta filters, and yellow filters instead of one or all of the red filters R, green filters G, and blue filters B.

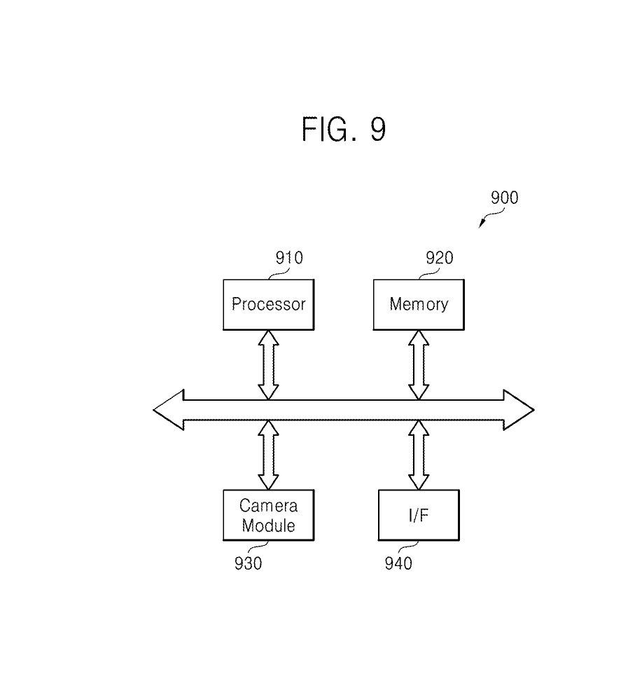

FIG. 9 is a block diagram of a 3D image sensing system including the camera module of FIG. 1. Referring to FIG. 9, the 3D image sensing system 900 is a device for providing a user with 3D images. The 3D images denote images including depth information and color information.

For example, the 3D image sensing system 900 may be included in a 3D digital camera or any electronic device including the 3D digital camera, including, for example, portable electronic devices. The 3D image sensing system 900 may process three dimensional image information. The 3D image sensing system 900 may include a camera module 930 and a processor 910 for controlling the operation of the camera module 930. The camera module 930 may be, for example, the camera module 10 shown in FIG. 1.

The 3D image sensing system 900 may further include an interface 940. The interface 940 may be an image display device such as 3D display device.

The 3D image sensing system 900 may further include a memory device 920 storing a movie or a still image captured by the camera module 930. The memory device 920 may be embodied into a non-volatile memory device. The non-volatile memory device may be embodied into Electrically Erasable Programmable Read-Only Memory (EEPROM), flash memory, Magnetic RAM (MRAM), Spin-Transfer Torque MRAM, Conductive bridging RAM (CBRAM), Ferroelectric RAM (FeRAM), Phase change RAM (PRAM) also referred to as Ovonic Unified Memory (OUM), Resistive RAM (RRAM or ReRAM), Nanotube RRAM, Polymer RAM (PoRAM), Nano Floating Gate Memory (NFGM), holographic memory, Molecular Electronics Memory Device, or Insulator Resistance Change Memory.

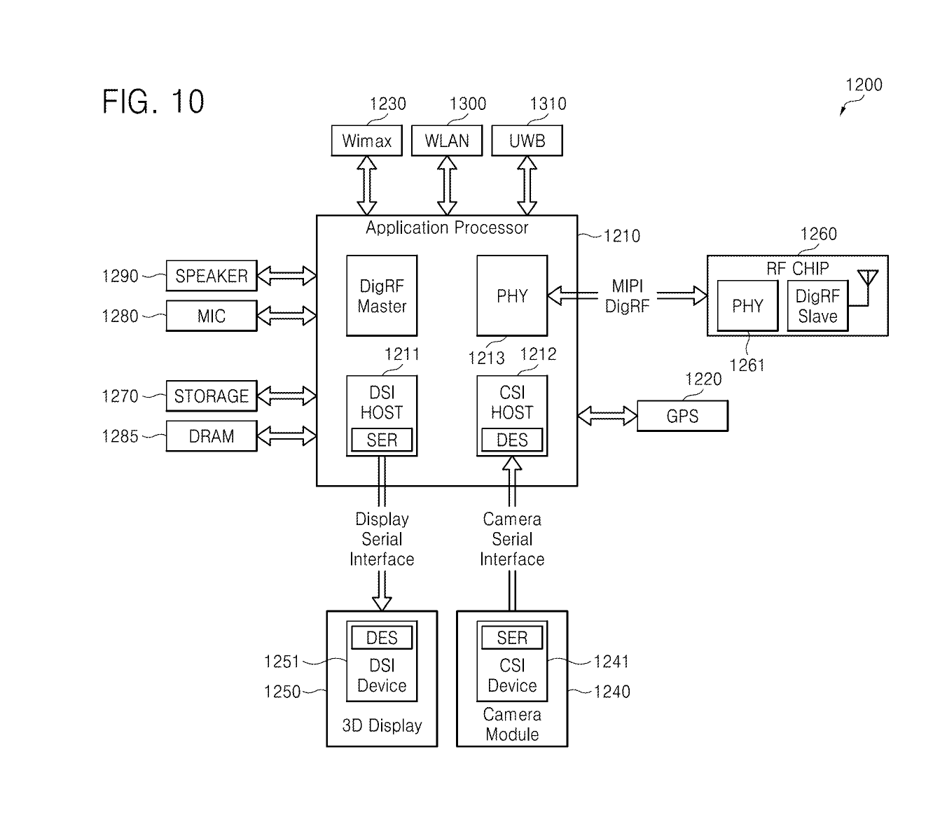

FIG. 10 is a block diagram of another 3D image sensing system including the camera module shown in FIG. 1. Referring to FIG. 10, the 3D image sensing system 1200 may be embodied into a data processing apparatus capable of using or supporting an MIPI interface, for example, mobile phone, personal digital assistant (PDA), portable multi-media player (PMP), or smart phone. The 3D image sensing system 1200 includes an application processor 1210, a camera module 1240, and a 3D display 1250.

A CSI host 1212 embodied in the application processor 1210 may perform serial communication with a CSI device 1241 of the camera module 1240 through a camera serial interface (CSI). At this time, for example, the CSI host 1212 may include an optical deserializer DES, and the CSI device 1241 may include an optical serializer SER. The camera module 1240 may be, for example, the camera module 10 of FIG. 1.

A DSI host 1211 included in the application processor 1210 may perform serial communication with a DSI device 1251 of a 3D display 1250 through a display serial interface (DSI). At this time, for example, the DSI host 1211 may include an optical serializer SER and the DSI device 1251 may include an optical deserializer DES.

The 3D image sensing system 1200 may further include an RF chip 1260 communicating with the application processor 1210. A PHY 1213 of the 3D image system 1200 and a PHY 1261 of the RF chip 1260 may exchange data according to MIPI DigRF. The 3D image sensing system 1200 may further include a GPS 1220, a storage 1270, a mike 1280, a DRAM 1285 and a speaker 1290, and may perform communication by using a Wimax 1230 module, WLAN 1300 module, and a UWB 1310 module.

The 3D image sensor and the system including the same according to at least one example embodiment of the inventive concepts may generate depth information and color information at the same time by allowing the color filter to pass wavelengths of visible region and wavelengths of infrared region.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A 3D image sensor comprising:
a first color filter configured to pass wavelengths of a first region of visible light and wavelengths of infrared light;
a second color filter configured to pass wavelengths of a second region of visible light and the wavelengths of infrared light; and
an infrared sensor configured to detect the wavelengths of infrared light passed through the first color filter.

2. The 3D image sensor of claim 1, further comprising:
a near-infrared pass filter located between the first color filter and the infrared sensor.

3. The 3D image sensor of claim 1, further comprising:
an infrared filter configured to pass the wavelengths of infrared light, wherein the infrared filter is located between the first color filter and the second color filter.

4. The 3D image sensor of claim 3, wherein the size of the first color filter and the size of the infrared filter are the same.

5. The 3D image sensor of claim 3, further comprising:
an optical detector configured to generate photoelectrons in response to the wavelengths of infrared light passed through the infrared filter, and the 3D image sensor is configured to compensate color information generated by the first color filter using the photoelectrons generated in response to the wavelengths of light passed through the infrared filter.

6. The 3D image sensor of claim 1, wherein the size of the infrared sensor is larger than the size of the first color filter.

7. A 3D image sensing system comprising:
a dual band pass filter configured to pass wavelengths of visible light and wavelengths of infrared light; and
a pixel array including a color pixel region configured to generate color information by passing the wavelengths of visible light.

8. The 3D image sensing system of claim 7, wherein the pixel array further includes an infrared sensor configured to detect the wavelengths of infrared light.

9. The 3D image sensing system of claim 8, wherein the pixel array includes a near-infrared filter configured to pass the wavelengths of infrared light such that the wavelengths of infrared light passed by the near-infrared filter are incident on the infrared sensor.

10. The 3D image sensing system of claim 9, wherein the pixel array includes a color filter configured to pass the wavelengths of infrared light and the wavelengths of visible light.

11. The 3D image sensing system of claim 10, wherein the size of the infrared sensor is larger than the size of the color filter.

12. The 3D image sensing system of claim 7, wherein the pixel array includes an infrared filter configured to pass the wavelengths of infrared light.

13. The 3D image sensing system of claim 12, wherein the size of the color filter and the size of the infrared filter are the same.

14. The 3D image sensing system of claim 12, wherein the pixel array includes an optical detector configured to generate photoelectrons in response to the wavelengths of infrared light passed through the infrared filter.

15. The 3D image sensing system of claim 7, wherein the 3D image sensing system is a portable electronic device.

16. A 3D image sensor comprising:
a first color filter configured to pass wavelengths of light within a first wavelength range of visible light and configured to pass wavelengths of infrared light;
a first color sensor configured to generate photoelectrons in response to the wavelengths of light of the first wavelength range of visible light; and
an infrared sensor located below the first color sensor and configured to generate photoelectrons in response to the wavelengths of infrared light.

17. The 3D image sensor of claim 16, further comprising:
a first infrared filter located in between the first color sensor and the infrared sensor, the first infrared filter being configured to filter out wavelengths of visible light and pass wavelengths of infrared light.

18. The 3D image sensor of claim 17, further comprising:
a second infrared filter configured to filter out wavelengths of visible light and pass wavelengths of infrared light, wherein the second infrared filter is located adjacent to the first color filter and above the first infrared filter.

19. The 3D image sensor of claim 18, further comprising:
an optical detector configured to generate photoelectrons in response to the wavelengths of infrared light passed through the second infrared filter, wherein the 3D image sensor is configured to compensate color information generated by the first color sensor based on the photoelectrons generated by the optical detector.

20. The 3D image sensor of claim 16, further comprising:
a second color filter configured to pass wavelengths of light within a second wavelength range of visible light and configured to pass wavelengths of infrared light, the first wavelength range being different from the second wavelength range; and
a second color sensor configured to generate photoelectrons in response to the wavelengths of light of the first wavelength range of visible light.
